(19) United States
(12) Patent Application Publication
(10) Pub. No.: US 2017/0367095 A1
(43) Pub. Date: Dec. 21, 2017

(54) SUBCHANNEL RELOCATION FOR FIXED-BANDWIDTH DEVICES

(71) Applicants: Xiaogang Chen, Hillsboro, OR (US); Qinghua Li, San Ramon, CA (US); Po-Kai Huang, West Lafayette, IN (US); Feng Jiang, Santa Clara, CA (US)

(72) Inventors: Xiaogang Chen, Hillsboro, OR (US); Qinghua Li, San Ramon, CA (US); Po-Kai Huang, West Lafayette, IN (US); Feng Jiang, Santa Clara, CA (US)

(21) Appl. No.: 15/396,255

(22) Filed: Dec. 30, 2016

Related U.S. Application Data
(60) Provisional application No. 62/350,253, filed on Jun. 15, 2016.

(51) Int. Cl. H04W 72/04; H04L 5/00; H04W 84/12

(52) U.S. Cl. CPC H04W 72/0453; H04W 72/042; H04W 72/0486; H04L 5/0007; H04W 72/0413; H04W 84/12

(57) ABSTRACT

A client station (STA), when operating in a wireless network, receives data sent by an access point (AP) on a first channel comprising at least one subchannel. During reception of the data on the first channel, the STA monitors channel availability of an additional set of one or more subchannels. In response to a detected availability of at least one newly-available subchannel, the STA sends at least one notification to the AP identifying STA-side availability of the newly-available subchannel(s). The STA subsequently receives data from the AP on the newly-available subchannel(s), which is sent in response to the at least one notification. The AP, when communicating data to the STA, receives the at least one notification from the STA and, in response thereto, initiates data transmission on one or more of the newly-available channel(s).

### PRIORITY APPLICATION

This application claims the benefit of priority to U.S. Provisional Application Ser. No. 62/350,253, filed Jun. 15, 2016, which is incorporated herein by reference in its entirety.

### TECHNICAL FIELD

Aspects of the disclosure relate generally to information processing and communications and, more particularly, to wireless networking. Some embodiments relate to client stations (STAs) and access point stations (APs) that operate according to the Institute of Electrical and Electronic Engineers (IEEE) 802.11 family of wireless networking standards. Some embodiments in particular relate to the IEEE 802.11ax standard currently under development, and to similar implementations. Some embodiments relate to high-efficiency (HE) wireless or high-efficiency WLAN or Wi-Fi (HEW) communications.

### BACKGROUND

Wireless networking has been continually growing in its ubiquity over the years. For example, access point stations (APs) that operate according to the media access control and physical layer specifications standardized in the Institute of Electrical and Electronic Engineers (IEEE) 802.11 family of wireless networking standards are presently found in homes, businesses, public facilities, transportation vehicles, and even wider areas such as being deployed to provide coverage throughout sonic cities. Client stations (STAs) are commonly integrated into a variety of electronic devices, such as personal computers, smartphones, tablets, and other portable computing devices, televisions, media players, and other appliances, cameras and other data-gathering devices, medical equipment, and countless other applications.

Wireless communications are generally conducted over defined channels in the frequency spectrum. In general, a channel is composed of subchannels that include a primary subchannel and a set of secondary subchannels. For instance, currently, 802.11ax devices are specified operate at a default 80-MHz bandwidth. Recently, a proposal was advanced to allow 20 MHz-only devices to operate alongside 80-MHz devices. From a network-capacity management perspective, this addition would introduce a number of challenges, such as the fact that 20-MHz devices present a source of co-channel interference to regular 80-MHz devices. As proposed, the 20 MHz-only device would only be permitted to operate on the primary 20-MHz subchannel. This restriction tends to limit the flexibility in dynamically managing system capacity, and tends to congest the primary 20-MHz subchannel.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a high-level system diagram illustrating a wireless local area network (WLAN) in accordance with some embodiments.

FIG. 2 illustrates a basic service set (BSS) and an overlapping basic service set (OBSS) in accordance with some embodiments

FIG. 3 is a block diagram illustrating a high-efficiency wireless (HEW) device in accordance with some embodiments.

FIGS. 4A and 4B are high-level system operational flow diagrams illustrating subchannel selection and related operations and messaging as performed by a client station (STA) and an access point (AP), according to various embodiments.

FIGS. 5A-5B are process flow diagrams illustrating operations performed by a STA device in connection with relocation of a subchannel according to some embodiments.

FIGS. 6A-6B are flow diagrams illustrating processes performed by an AP in connection with subchannel relocation according to some embodiments.

### DETAILED DESCRIPTION

Embodiments are directed generally to wireless communications between mobile or fixed stations in which there are selectable subchannels for single-subchannel devices, such as 20 MHz-only devices, over which the communications may take place. In the present context, a channel configuration includes a selected set of one or more channels, or subchannels, over which the wireless communications are conducted. The IEEE 802.11 family of wireless local area networking (WLAN) standards provide for variable and selectable channel configurations, and for the sake of brevity the present disclosure describes various embodiments in the context of certain IEEE 802.11 WLAN implementations. However, it will be understood that the principles described herein may be suitably adapted to be applied in other types of wireless communications regimes, whether presently known, or arising in the future. These other types of wireless communications regimes may be other types of WLANs, peer-to-peer arrangements, wireless ad-hoc networks, wide-area networks (WANs), or entirely different systems.

One notable feature of recent IEEE 802.11 standard developments, such as 802.11ax, is the support for wider channels as well as dynamic channel access. For example, assume 4 sub-channels each with 20 MHz of bandwidth. An 802.11ax access point (AP) that assesses all subchannels as free can potentially concurrently transmit on all 4 sub-channels, significantly increasing its bandwidth and hence throughput. If some of the sub-channels are busy, the AP can still potentially transmit on the remaining free sub-channels.

Aspects of the embodiments are directed to a solution, in a high-efficiency (HE) WLAN (or similar) context in which STA devices normally operate according to a defined standard channel bandwidth, for subchannel-limited STA devices to work on a selectable or assignable subchannel other than the primary subchannel. In one example embodiment, a STA may initiate wireless connectivity with AP on a first subchannel (e.g., the primary subchannel) having a subchannel bandwidth that is a fractional portion of a default channel bandwidth defined for the wireless network. According to various embodiments, the AP or STA may determine that a change to a different subchannel is warranted. This may be due to the presence of interference on the first subchannel, or due to a discovered availability of greater throughout on a different subchannel. Thus, the AP or STA may generate and send a subchannel change request message over the current subchannel, or over the primary subchannel in some cases, to the STA or AP, respectively. The subchannel change request message may be a medium-access control (MAC) frame, for instance, which indicates one or more other subchannels that may be used in lieu of the current subchannel. These one or more other subchannels may be secondary subchannels. In response to the subchannel change request message, the STA or AP receiving the message may encode a subchannel change response message for transmission to the sender, and initiate relocation of communication with the AP to the other subchannel. In some embodiments, the STA or AP receiving the subchannel change request message may perform its own determination of which subchannel to which to switch in response to the request message containing more than one option of subchannel.

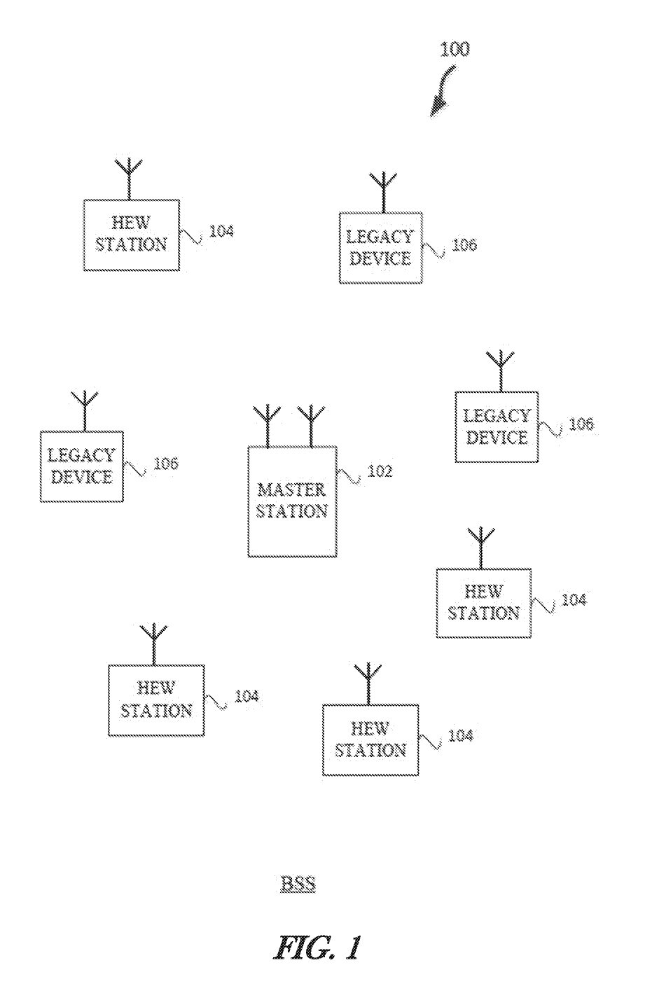

FIG. 1 is a high-level system diagram illustrating a WLAN in accordance with some embodiments. The WLAN may comprise a basis service set (BSS) 100 that may include a master station 102, which may be an access point station (AP), a plurality of high-efficiency wireless (HEW) (e.g., IEEE 802.11ax) client stations (STAs) 104 and a plurality of legacy (e.g., IEEE 802.11n/ac) STA devices 106.

The master station 102 may be an AP operating in accordance with one or more standards of the IEEE 802.11 family of standards to transmit and receive data communications. The master station 102 may be a base station. The master station 102 may use other communications protocols as well as the IEEE 802.11 protocols. The IEEE 802.11 protocol may be IEEE 802.11ax. The IEEE 802.11 protocol may include a multiple access technique such as, for example, orthogonal frequency division multiple-access (OFDMA), time division multiple access (TDMA), and/or code division multiple access (CDMA). The IEEE 802.11 protocol may also include space-division multiple access (SDMA) and/or multiple-user multiple-input multiple-output (MU-MIMO).

The legacy devices 106 may operate in accordance with one or more of IEEE 802.11 a/b/g/n/ac/ad/af/ah/aj, or another legacy wireless communication standard. The legacy devices 106 may be STAs or IEEE STAs. The HEW STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques.

In some embodiments, a HEW frame may be configurable to have the same bandwidth as a subchannel. The bandwidth of a subchannel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 5 MHz and 10 MHz, or a combination thereof or another bandwidth that is less or equal to the available bandwidth may also be used. In some embodiments the bandwidth of the subchannels may be based on a number of active subcarriers. In some embodiments the bandwidth of the subchannels are multiples of 26 (e.g., 26, 52, 104, etc.) active subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

Some embodiments relate to HEW communications. In accordance with some IEEE 802.11ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger frame or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, the HEW STAs 104 may operate on a sub-channel smaller than the operating range of the master station 102. During the HEW control period, legacy stations may refrain from communicating.

In accordance with some embodiments, during the master-sync transmission the HEW STAs 104 may contend for the wireless medium with the legacy devices 106 being excluded front contending for the wireless medium during the master-sync transmission. In some embodiments the trigger frame may indicate an uplink (UL) UL-MU-MIMO and/or UL OFDMA control period.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

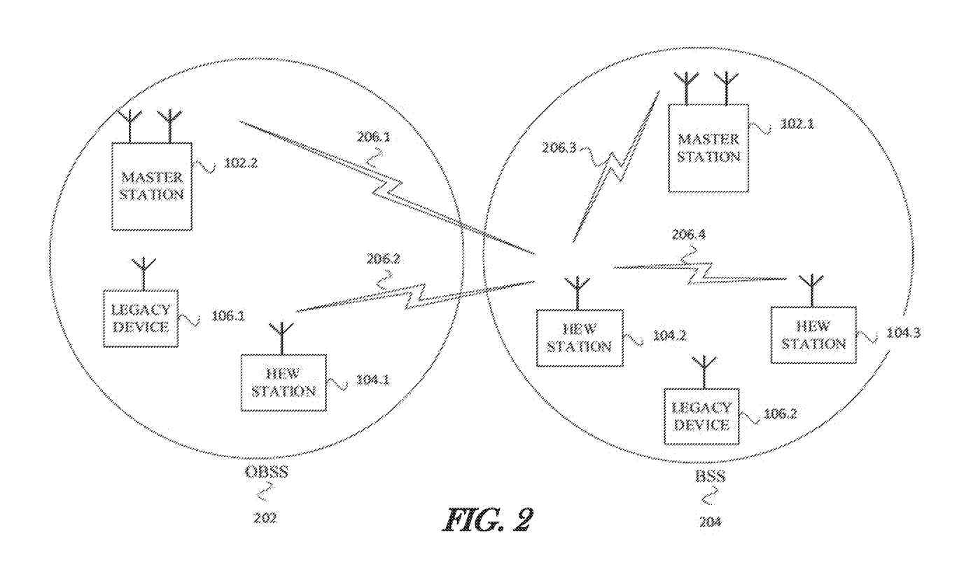

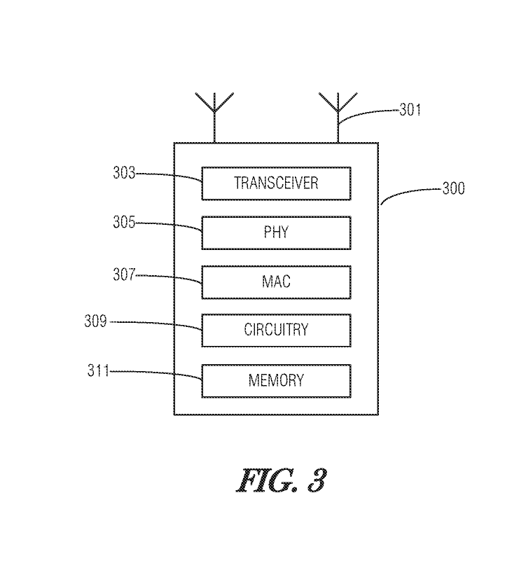

FIG. 2 illustrates a basic service set (BSS) and an overlapping basic service set (OBSS) in accordance with some embodiments. Illustrated in FIG. 2 are an OBSS 202 and BSS 204. The OBSS 202 includes one or more master stations 102, one or more HEW stations 104, and one or more legacy devices 108. The HEW station 104.1 and legacy device 106.1 are associated with the master station 102.2. The master station 102.2 has an identification (not illustrated) for the OBSS 202, which may be termed a BSS identification (BSSID). In some embodiments, the identification is termed the color of the OBSS 202. The HEW station 104.1 stores a MAC address (see FIGS. 3, 4, and 5) of the master station 102.2. The OBSS 202 is a BSS 100. The OBSS 202 is termed an OBSS 202 to BSS 204 because some of the signals 206 overlap with the BSS 204.

The BSS 204 includes one or more master stations 102, one or more HEW stations 104.2, 104.3, and one or more legacy devices 106.2. The HEW stations 104.2 and 104.3 and legacy device 106.1 are associated with the master station 102.1. The master station 102.1 has an identification (not illustrated) for the BSS 204, which may be termed a BSSID. In some embodiments, the identification is termed the color of the BSS 204. The HEW stations 104.2 and 104.3 store a MAC address (see FIGS. 3, 4, and 5) of the master station 102.1.

Signal 206.1 is transmitted from the master station 102.2 and received by HEW station 104.2. Signal 206.2 is transmitted from HEW station 104.1 and received by HEW station 104.2. Signal 206.4 is transmitted from the HEW station 104.3 and received by HEW station 104.2. Signal 206.3 is transmitted by master station 102.1 and received by HEW station 104.2. The signals 206 may be frames transmitted by a master station 102, HEW station 104, legacy device 106, and/or another wireless device (not illustrated).

FIG. 3 is a block diagram illustrating a HEW device in accordance with some embodiments. HEW device 300 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 300 may be suitable for operating as master station 102 (FIG. 1) or a HEW STA 104 (FIG. 1). In accordance with embodiments, HEW device 300 may include, among other things, a transmit/receive element 301 (for example an antenna), a transceiver 303, physical (PHY) circuitry 305, and media access control (MAC) circuitry 307. PHY circuitry 305 and MAC circuitry 307 may be HEW compliant layers and may also be compliant with one or more legacy IEEE 802.11 standards. MAC circuitry 307 may be arranged to configure frames such as a physical layer convergence procedure (PLCP) protocol data unit (PPDUs) and arranged to transmit and receive PPDUs, among other things. HEW device 300 may also include circuitry 309 and circuitry 309 configured to perform the various operations described herein. The circuitry 309 may be coupled to the transceiver 303, which may be coupled to the transmit/receive element 301. While FIG. 3 depicts the circuitry 309 and the transceiver 303 as separate components, the circuitry 309 and the transceiver 303 may be integrated together in an electronic package or chip.

In some embodiments, the MAC circuitry 307 may be arranged to contend for a wireless medium during a contention period to receive control of the medium for the HEW control period and configure an HEW Physical Layer Convergence Protocol Data Unit (PPDU). In some embodiments, the MAC circuitry 307 may be arranged to contend for the wireless medium based on channel contention settings, a transmitting power level, and a CCA level.

One of the more notable recent enhancements to the 802.11 standard is the support for wider channels, as well as both, dynamic, and static channel access More recent releases (e.g., 802.11ac and later) call for all devices to support 20, 40, and 80 MHz channels. In addition, support is provided for operation on 160-MHz channels. Similar to legacy versions such as 802.11n, channels that are 40 MHz or wider always require a primary 20-MHz-wide sub-channel. Additionally, 80-MHz channels have a primary 40-MHz (which includes the primary 20-MHz) subchannel and a secondary 40-MHz subchannel. The same applies to 160-MHz channels.

In order for a STA to be able to transmit an 80 MHz packet, two conditions must be true: 1) The primary channel needs to be idle for DIFS plus the back-off counter duration; and 2) All secondary sub-channels must have been idle for a duration of PIFS immediately preceding the expiration of the back-off counter.

Conventionally, should any of the secondary sub-channels be busy, the STA can follow either static or dynamic channel access rules. In static channel access, if the secondary subchannel is busy, the STA will choose a random backoff period within the current contention window size to restart the contention process and continue to attempt until no interference is present in any of the subchannels. In dynamic channel access, the STA may attempt to transmit over a narrower channel using 20 or 40 MHz instead. This represents a more flexible approach, which allows for more efficient resource allocation because the STA retains the capability to transmit, albeit over a fraction of the original bandwidth. According to recent standard revisions of 802.11, all transmission always have to include the primary subchannel in order to inform the receiver of which channels the transmitter will use.

The PHY circuitry 305 may be arranged to transmit the HEW PPDU. The PHY circuitry 305 may include circuitry for modulation/demodulation, upconversion/downconversion, filtering, amplification, etc. In some embodiments, the circuitry 309 may include one or more processors. The circuitry 309 may be configured to perform functions based on instructions being stored in a RAM or ROM, or based on special purpose circuitry. The circuitry 309 may include processing circuitry and/or transceiver circuitry in accordance with some embodiments. The circuitry 309 may include a processor such as a general purpose processor or special purpose processor. The circuitry 309 may implement one or more functions associated with transmit/receive elements 301, the transceiver 303, the PHY circuitry 305, the MAC circuitry 307, and/or the memory 311.

In some embodiments, the transmit/receive elements 301 may be two or more antennas that may be coupled to the PHY circuitry 305 and arranged for sending and receiving signals including transmission of the HEW frames. The transceiver 303 may transmit and receive data such as HEW PPDU and frames that include an indication that the HEW device 300 should adapt the channel contention settings according to settings included in the frame. The memory 311 may store information for configuring the other circuitry to perform operations for configuring and transmitting HEW frames and performing the various operations to perform one or more of the functions and/or methods described herein.

In some embodiments, the HEW device 300 may be configured to communicate using OFDM communication signals over a multicarrier communication channel. In some embodiments, HEW device 300 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 300 may use 4× symbol duration of 802.11n or 802.11ac.

In some embodiments, an HEW device 300 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 301 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 300 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Examples, as described herein, may include, or may operate on, one or more engines. Engines are tangible entities (e.g., hardware) capable of performing specified operations and may be configured or arranged in a certain manner. In an example, circuits may be arranged (e.g., internally or with respect to external entities such as other circuits) in a specified manner as an engine. In an example, the whole or part of one or more computer systems (e.g., a standalone, client or server computer system) or one or more hardware processors may be configured by firmware or software (e.g., instructions, an application portion, or an application) as an engine that operates to perform specified operations. In an example, the software may reside on a machine readable medium. In an example, the software, when executed by the underlying hardware of the engine, causes the hardware to perform the specified operations.

Accordingly, the term “engine” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which engines are temporarily configured, each of the engines may be instantiated at a particular moment in time. For example, where the engines comprise a general-purpose hardware processor configured using software, the general-purpose hardware processor may be configured as respective different engines at different times. Software may accordingly configure a hardware processor, for example, to constitute a particular engine at one instance of time and to constitute a different engine at a different instance of time.

Some embodiments may be implemented using software and/or firmware in combination with execution hardware, such as the processing elements described above. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

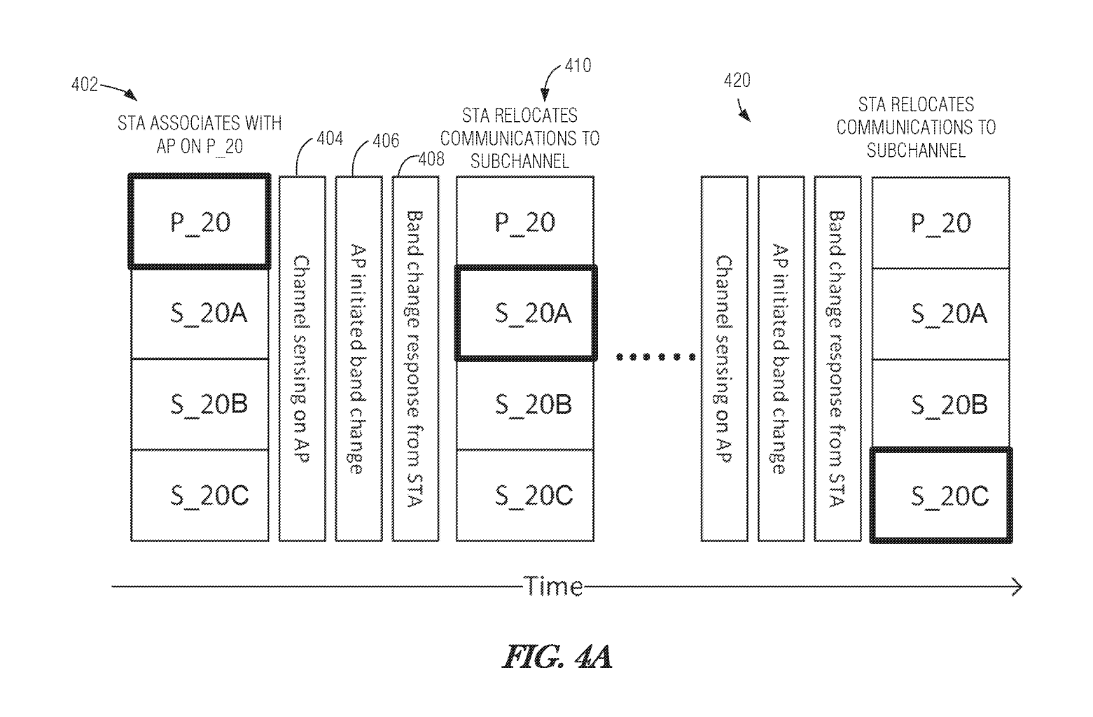

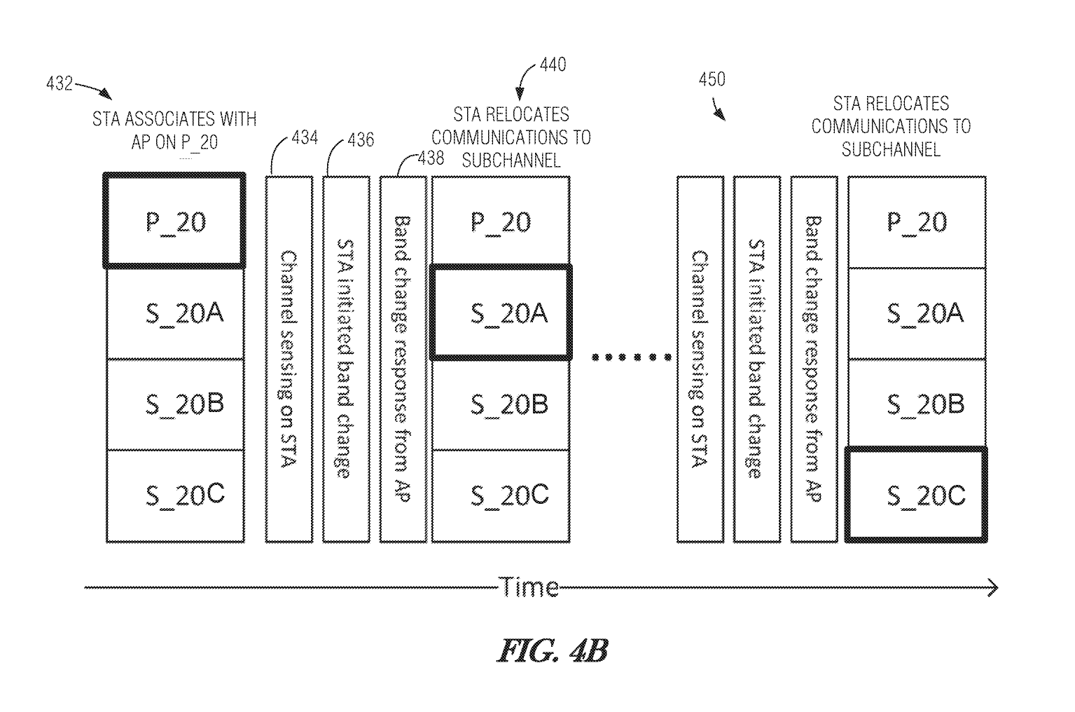

FIGS. 4A and 4B are high-level system operational flow diagrams illustrating subchannel selection and related operations and messaging as performed by a STA and an AP, according to various embodiments. FIG. 4A depicts a subchannel change initiated by the AP; whereas FIG. 4B depicts a subchannel change initiated by the STA.

Referring first to FIG. 4A, as an initial condition, the STA has associated with the AP on primary 20-MHz subchannel P_20. Primary subchannel P_20 is generally used as the subchannel on which initial connectivity operations take place (e.g., authentication and association), and is the subchannel that is continuously monitored by the AP according to some implementations. Secondary subchannels S_20A-S_20C are not used by the STA at this initial point in the example depicted. However, it should be noted that the initial starting point may be on a subchannel other than primary subchannel P_20, depending on prior activity or on the particular system configuration, which may designate a secondary subchannel as a subchannel to use for initialization.

After or during the association, the AP may assign a 20-MHz subchannel on which the STA is to park. Parking in the present context refers to the STA maintaining synchronization with the AP on the given subchannel. The assigned subchannel may be primary subchannel P_20 or one of the secondary subchannels S_20A-S_20C. The STA may communicate with the AP over the assigned 20-MHz subchannel directly or when solicited by a Trigger frame calling for transmission by the AP.

At 404, the AP may scan multiple 20-MHz subchannels A_20A-S_20C to assess channel clarity or, conversely, congestion state, interference, etc. If the AP determines one or more 20-MHz subchannels that are less busy than the current subchannel where the STA is parked, the AP initiates a subchannel change procedure. The AP may also base its selection of the one or more candidate subchannels on current or planned usage of the various subchannels in its communications with other STA devices. At 406 the AP sends a subchannel change request message to STA to initiate the subchannel relocation negotiation.

The subchannel change request message may be a MAC frame, for instance. The subchannel change request message may be sent on the current subchannel on which the STA is parked (which may be primary subchannel P_20, or one of the secondary subchannels S_20A-S_20C). In one type of embodiment, the AP can identify a set of candidate subchannels that would be usable for communications with the STA, and indicate that set of subchannels in the subchannel change request message for the STA. The STA may then select a suitable subchannel from among the candidate subchannels in the request message. Advantageously, in this approach, the STA may take into account the interference in its immediate environment when selecting the preferred subchannel from among the candidates.

In response to receiving the subchannel change request message, the STA may acknowledge its receipt of the message at 408 using a subchannel change response message. The subchannel change response message may be sent on the current subchannel, which may be primary subchannel P_20 or one of the secondary subchannels S_20A-S_20C. In another embodiment, if the current subchannel is not the primary subchannel P_20, the STA may nonetheless send the subchannel change response message on the primary subchannel P_20. In embodiments where the STA selects a subchannel from among a candidate set, the subchannel change response message may indicate that subchannel selection.

In a related embodiment, prior to sending the subchannel change response message at 408, the STA may check the AP-specified (or STA-selected) new subchannel for congestion, interference, etc., to verify the availability and performance of the subchannel before relocating to that subchannel. If STA verifies that the assigned subchannel is usable, STA may accept AP's scheduling by sending the subchannel change response frame.

At 410, the STA relocates to the new subchannel. Relocation may involve adjusting the transceiver circuitry to set filtering and re-synchronization to the new subchannel's frequency band. In a related embodiment, relocation to the new subchannel is completed after a certain defined time duration, during which communications activity is postponed or suppressed by the AP and STA to allow the STA sufficient time to stabilize its transceiver at the new subchannel.

Otherwise, STA may reject the subchannel change request by affirmatively rejecting the request or passively rejecting the request. As examples of passive rejection, the STA may disregard the subchannel change request message from the AP, in which case the AP will interpret the lack of response over a predefined response window as a rejection. As an example of an affirmative rejection, the STA may sending a subchannel change denial message to the AP, which may be in the form of a subchannel change response message with an indicator representing the rejection. In either case of rejection, the STA will continue to remain parked on the current subchannel. The AP may retry the subchannel change at a future time following a subchannel change standoff period, which may be predefined according to the system policies.

Operations 420 depict a series of similar actions to the process described above with reference to 402-410, except that the subchannel relocation proceeds from an initial starting point where the current subchannel is a secondary subchannel, e.g., S_20A, rather than the primary subchannel P_20. In this example, the AP initiates relocation of subchannel from secondary subchannel S_20A to secondary subchannel S_20C.

In FIG. 4B a procedure where the subchannel change is initiated by the STA is depicted according to some embodiments. At 432, the STA associates with the AP on primary subchannel P_20. As in the AP-initiated subchannel relocation examples discussed above, the initial subchannel on which the association takes place may be a secondary subchannel if the system is so configured according to other embodiments.

If the STA successfully associates to the AP, it will park on primary channel P_20 (or the default initial subchannel if it is defined as being other than primary channel P_20) and communicate with the AP on that subchannel. After, or during the association, the AP may assign a different 20-MHz subchannel for the STA to park. The STA may communicate with the AP over that assigned 20 MHz subchannel, which of course may remain the primary subchannel P_20 if no other subchannel is assigned.

At 434, the STA scans one or more other 20-MHz subchannels than the current subchannel. If the STA determines that one or more 20 MHz subchannels have greater availability (e.g., less congestion or less interference) than the current subchannel, the STA may initiate a subchannel change negotiation at 436. Accordingly, the STA may generate and send a subchannel change request message (e.g., in the form of a MAC frame) to the AP. The subchannel change request message may be sent on the current subchannel (which may be the primary subchannel P_20 or a secondary subchannel S_20A-S_20C), or on the primary subchannel P_20 if the current subchannel is one of the secondary subchannels as another embodiment. In the subchannel change request message, the STA may indicate the one or more candidate subchannels that it determined to be potentially better-performing subchannels to carry communications to and from the AP.

According to some embodiments, the AP is permitted to either accept, or not accept, the subchannel change request from the STA. If the AP accepts the subchannel change request from the STA, the AP may send a subchannel change response message at 438. The subchannel change response message may be a MAC frame, and it may be transmitted on the current subchannel (which at this stage in the example depicted in primary subchannel P_20).

If the subchannel change request message contains more than one candidate subchannel, the AP may perform measurements of those candidate subchannels to determine a preferred subchannel to be selected. From the perspective of the AP, the preferred subchannel to be selected may be the subchannel that has the best performance (e.g., greatest capacity, least congestion, least interference, etc.) as measured in the local vicinity of the AP. The AP may also base its selection of the preferred subchannel on current or planned usage of the various subchannels in its communications with other STA devices.

At 438, the AP generates and sends the subchannel change response message to the STA. The subchannel change response message may indicate which subchannel is to be used by the STA if this is not implicit (e.g. if the STA provided more than one candidate subchannel in the request message). In response to receiving the subchannel change response message, the STA will relocate to the new subchannel, shown as S_20A in the example depicted, at 440, and park on that subchannel to send and receive communications to and from the AP.

The AP may determine that relocation to a different subchannel as per the request by STA is not warranted. This determination may be based, for instance, on the AP's knowledge of current or planned communications with other STA devices on other subchannels, congestion or interference measurements of the candidate subchannel(s) indicated in the subchannel change request message, etc. Accordingly, the AP may actively or passively reject the subchannel change request. Passive rejection may involve simply disregarding the subchannel change request, in which case the STA will infer a rejection due to a lack of response during a predefined response time window. An active rejection may involve the AP sending a subchannel change response message indicating the rejection. Accordingly, if the subchannel change request is rejected, the STA will continue being parked on the current subchannel. The STA may re-initiate a subchannel change request after passage of a standoff time period that may be preconfigured in the STA according to the applicable system policy.

Operations 450 depict a series of similar actions to the process described above with reference to 432-440, except that the subchannel relocation proceeds from an initial starting point where the current subchannel is a secondary subchannel, e.g., S_20A, rather than the primary subchannel P_20. In this example, the STA initiates relocation of subchannel from secondary subchannel S_20. A to secondary subchannel S_20C.

In general, it takes some time for a 20 MHz-only STA relocate to a new subchannel. Certain operations, such as clock adjustment and synchronization for operation at a new subchannel, may take more time than the SIFS time, e.g., 16 microseconds, depending on the hardware implementation. To address this delay, in some embodiments, the AP is configured to reserve time for the STA's clock transition. For example, the AP may abstain from scheduling an STA to park on a new subchannel within about the SIFS time following transmission of the applicable scheduling frame. As an example, the transition delay may be at least 50 microseconds for relocation to a new subchannel to allow time for the STA's transceiver's clock to stabilize at its new settings.

In a related embodiment, the subchannel change request message may be sent by an AP using group addressing/group ID to multiple STA devices simultaneously. This may be followed by the AP sending a Trigger frame to solicit subchannel change response messages from the multiple STAs using multiple-access techniques such as UL MU MEMO or UL MU OFDMA.

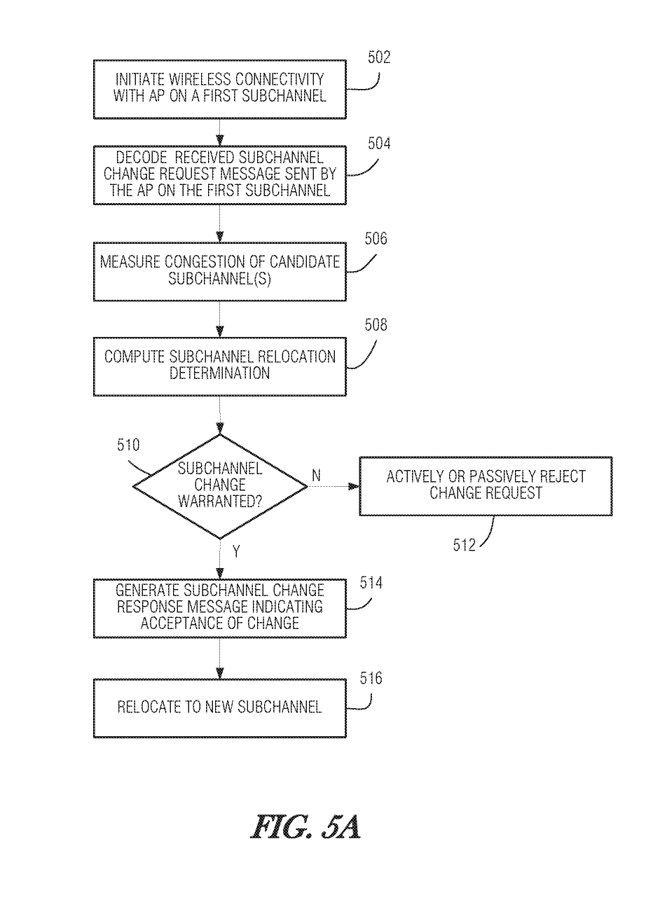

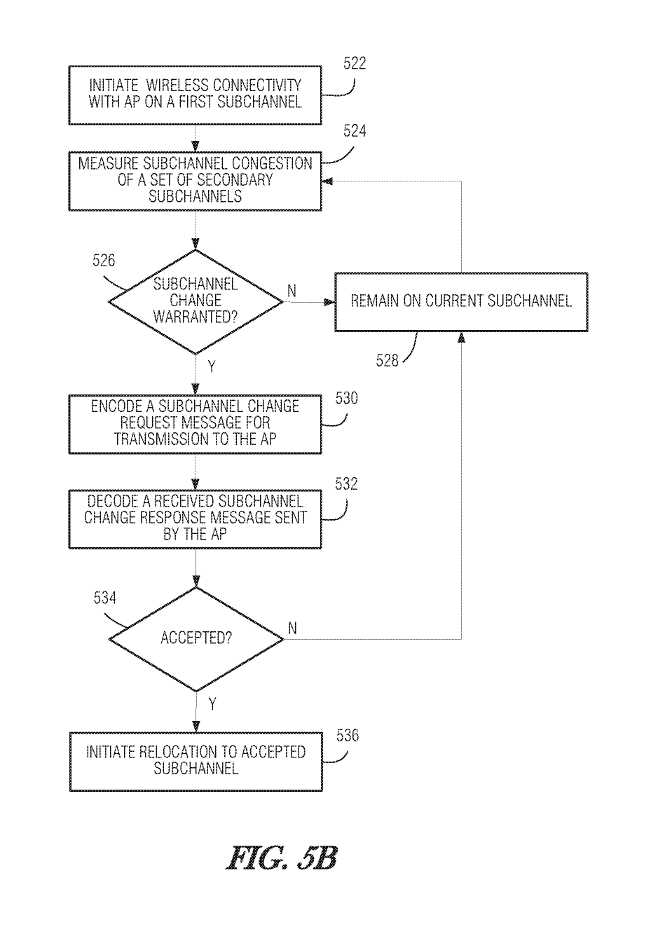

FIGS. 5A-5B are process flow diagrams illustrating operations performed by a STA device in connection with relocation of a subchannel according to some embodiments. FIG. 5A depicts a process executed by a STA for receiving and responding to a subchannel change request message from an AP device; FIG. 5B illustrates a process executed by a STA for initiating the subchannel relocation process. It should be noted that the operations of FIGS. 5A-5B are not mutually exclusive—a STA device may be both, an initiator of, and responder to, subchannel change relocations.

Turning first to FIG. 5A, at 502, the STA initiates wireless connectivity with the AP on a first subchannel, which may be a primary subchannel, for example. The bandwidth of each subchannel is a fractional portion of a default channel bandwidth defined for the wireless network. For example, in a network in which channels are by default 80 MHz wide, subchannels may be 8 MHz, 10 MHz, 20 MHz, 40 MHz, or the like. At 504, a processor of the STA decodes a received subchannel change request that was sent by the AP and received by the transceiver circuitry of the STA over the first subchannel. The subchannel change request message may indicate a second subchannel for the STA to use for communication with the AP, where the second subchannel is a secondary subchannel. The second subchannel indicated in the subchannel change request message may be one of several candidate subchannels identified by the AP.

In an embodiment where the STA is to simply follow an instruction of the AP to change subchannels to a specified subchannel, the STA may forgo operations 508-514, and proceed directly to operation 516, where the STA relocates to the specified subchannel. However, in other embodiments, the STA is granted some decision-making authority. Accordingly, at 506, in response to the subchannel change request message, the STA measures congestion of the candidate subchannel or subchannels indicated in the message to determine, at 508, a subchannel that tends to provide the best performance in terms of the channel quality measurements made by the STA. These may include sonic measure of congestion, interference, channel clarity, etc. At 510, the STA decides if the subchannel change requested by the AP is warranted. To make this determination, the STA may compare the candidate subchannel or subchannels proposed by the AP against the current subchannel. In one example, a performance margin is to be exceeded by the comparison to justify the time and energy to be expended in relocating to a new subchannel.

If a relocation of subchannel is not warranted, the STA remains at the current subchannel, and actively or passively rejects the subchannel change request. As discussed above, passive rejection may involve simply not responding to the change request, whereas active rejection involves sending a suitable message to the AP. In the case of acceptance of the subchannel change request, at 514, the STA generates a subchannel change response message and transmits the response message to the AP. In cases where the STA selects a subchannel from a set of candidate subchannels, the response message may contain an indication of the subchannel selection by the AP. At 516, the STA proceeds to relocate to the new subchannel.

In the process of FIG. 5B, the STA initiates connectivity with the AP at 522. Initiation of connectivity may involve authentication and association operations, for example, as defined in the applicable WLAN standard. At 524, the STA measures subchannel congestion of a set of secondary subchannels. At 526, the STA determines if a change to a new subchannel is warranted. This determination may be based on a comparison of the current subchannel with those subchannels that were measured at 524. A performance margin as discussed above may be applied as part of the decision at 526.

In the case of the change not being warranted, the process advances to 528, where no further action is taken. After some standoff time duration, the STA may again loop back to 524 to re-measure the other subchannels.

If the subchannel change is warranted, the process advances to 530, where the STA encodes a subchannel change request message for transmission to the AP. At 532, the STA receives and decodes a responsive message that may indicate acceptance or rejection of the subchannel change request. Decision 534 determines if the change request was or was not accepted. In the negative case, the process loops back to 528, where the STA may wait to try again later. Otherwise, in the positive case, i.e., where the AP has indicated an acceptance of a subchannel change, the process advances to 536, where the STA initiates relocation to the new subchannel according to the agreed-upon subchannel. The new subchannel may be explicitly or implicitly indicated in the subchannel change response message, as discussed above.

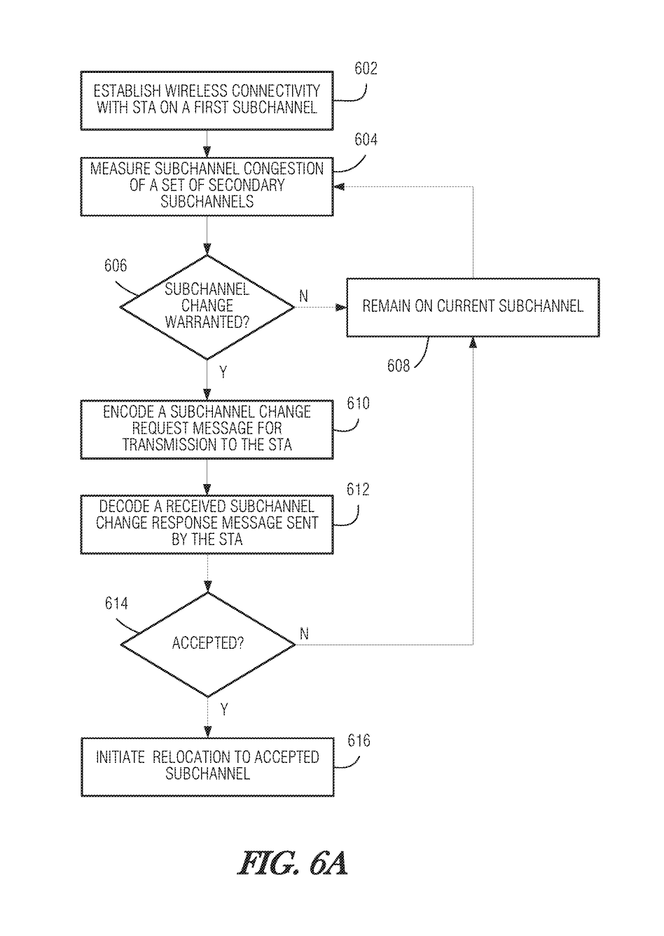

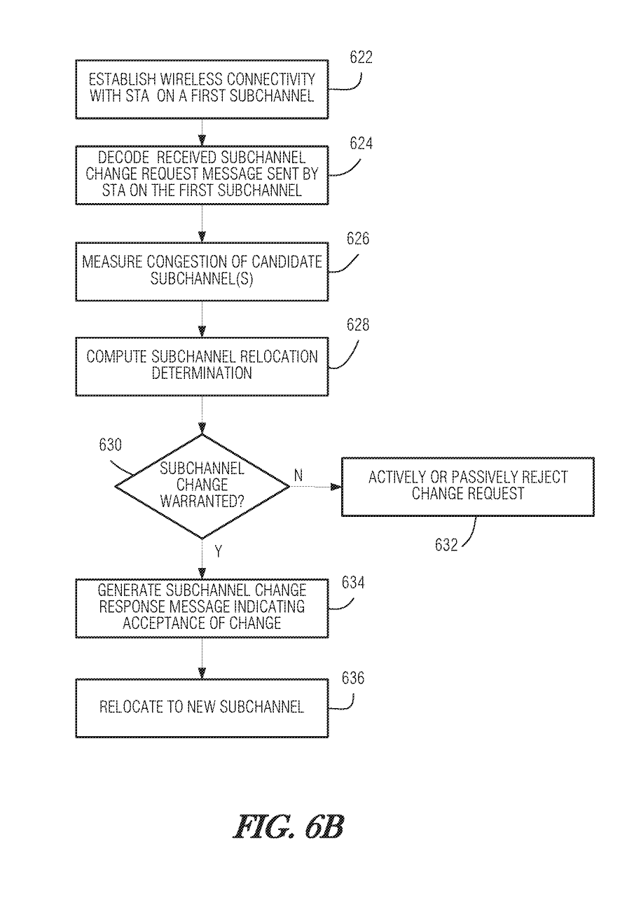

FIGS. 6A-6B are flow diagrams illustrating processes performed by an AP in connection with subchannel relocation according to some embodiments. FIG. 6A illustrates a process flow of an AP that initiates the change to a new subchannel, whereas FIG. 6B illustrates a process where the AP responds to a subchannel change request initiated by a STA.

In FIG. 6A, the AP establishes wireless connectivity with the STA on a first subchannel at 602. The first channel may be a primary subchannel or a secondary subchannel according to various embodiments. At 604, the AP measures other subchannels for congestion, interference, or other performance measures. These include secondary subchannels. At 606, the AP determines if a change to a new subchannel is warranted. This determination may be based on a comparison of the current subchannel with those subchannels that were measured at 604. A performance margin as discussed above may be applied as part of the decision at 606.

In the case of the change not being warranted, the process advances to 608, where no further action is taken. After some standoff time duration, the AP may again loop back to 604 to re-measure the other subchannels.

If the subchannel change is warranted, the process advances to 610, where the AP encodes a subchannel change request message for transmission to the STA. At 612, the AP receives and decodes a responsive message from the STA that may indicate acceptance or rejection of the subchannel change request. Decision 614 determines if the change request was or was not accepted. In the negative case, the process loops back to 608, where the AP may wait to try again later. Otherwise, in the positive case, i.e., where the STA has indicated an acceptance of a subchannel change, the process advances to 616, where the AP initiates relocation to the new subchannel according to the agreed-upon subchannel. The new subchannel may be explicitly or implicitly indicated in the subchannel change response message, as discussed above.

In a related embodiment, the AP waits for a predefined period of time before initiating any communications to the STA to allow for the STA to complete its transition to the new subchannel. This period of time may roughly correspond to, e.g., slightly exceed, the SIFS duration.

In the process depicted in FIG. 6B, the AP is responsive to a STA-initiated subchannel relocation request, at 622, the AP establishes wireless connectivity with the STA on a first subchannel, which may be a primary subchannel, for example. The bandwidth of each subchannel is a fractional portion of a default channel bandwidth defined for the wireless network. For example, in a network in which channels are by default 80 MHz wide, subchannels may be 8 MHz, 10 MHz, 20 MHz, 40 MHz, or the like. At 624, a processor of the AP decodes a received subchannel change request that was sent by the STA and received by the transceiver circuitry of the AP over the first subchannel. The subchannel change request message may indicate a second subchannel for the AP to use for communication with the STA, where the second subchannel is a secondary subchannel. The second subchannel indicated in the subchannel change request message may be one of several candidate subchannels identified by the STA.

At 626, in response to the subchannel change request message, the AP measures congestion of the candidate subchannel or subchannels indicated in the message to determine, at 628, a subchannel that tends to provide the best performance in terms of the channel quality measurements made by the AP. These may include sonic measure of congestion, interference, channel clarity, etc. At 630, the AP decides if the subchannel change requested by the STA is warranted. To make this determination, the AP may compare the candidate subchannel or subchannels proposed by the STA against the current subchannel. In one example, a performance margin is to be exceeded by the comparison to justify the time and energy to be expended in relocating to a new subchannel.

If a relocation of subchannel is not warranted, the AP remains at the current subchannel, and actively or passively rejects the subchannel change request. As discussed above, passive rejection may involve simply not responding to the change request, whereas active rejection involves sending a suitable message to the STA. In the case of acceptance of the subchannel change request, at 634, the AP generates a subchannel change response message and transmits the response message to the STA. In cases where the AP selects a subchannel from a set of candidate subchannels, the response message may contain an indication of the subchannel selection by the STA. At 636, the AP proceeds to relocate to the new subchannel.

### Additional Notes & Examples

Example 1 is an apparatus for a high-efficiency (HE) station (STA) for operation in a wireless network for which channels are defined to include a primary subchannel and a plurality of secondary subchannels, the apparatus comprising: memory; and processing circuitry configured to: initiate wireless connectivity with an access point (AP) on a first subchannel having a subchannel bandwidth that is a fractional portion of a default channel bandwidth defined for the wireless network; decode a received subchannel change request message sent by the AP on the first subchannel, the subchannel change request message indicating a second subchannel for the STA to use for communication with the AP, wherein the second subchannel is a secondary subchannel; in response to the subchannel change request message, encode a subchannel change response message for transmission to the AP; and initiate relocation of communication with the AP to the second subchannel.

In Example 2, the subject matter of Example 1 optionally includes wherein the processing circuitry is to further configure the STA to: in response to the subchannel change request message, wait for a predefined delay duration before initiation of relocation of communication to the second subchannel.

In Example 3, the subject matter of any one or more of Examples 1-2 optionally include wherein the subchannel change request message indicates a plurality of available secondary subchannels, and wherein the processing circuitry is to further configure the STA to: in response to the subchannel change request message, select the second subchannel from among the plurality of available secondary subchannels as indicated in the subchannel change request message, and indicate the selected second subchannel in the subchannel change response message.

In Example 4, the subject matter of any one or more of Examples 1-3 optionally include wherein the processing circuitry is to further configure the STA, in response to the subchannel change request message, to: measure channel congestion of the second subchannel; compute a relocation determination, based on the channel congestion of the second subchannel, whether relocation to the second subchannel meets predefined relocation criteria; and wherein the subchannel change response message and the relocation to the second are in response to the relocation determination meeting the predefined relocation criteria.

In Example 5, the subject matter of any one or more of Examples 1-4 optionally include wherein the first subchannel is the primary subchannel.

In Example 6, the subject matter of any one or more of Examples 1-5 optionally include wherein the subchannel change response message for transmission to the AP is encoded for transmission on the primary subchannel.

In Example 7, the subject matter of any one or more of Examples 1-6 optionally include wherein the subchannel change response message for transmission to the AP is encoded for transmission on the first subchannel.

In Example 8, the subject matter of any one or more of Examples 1-7 optionally include wherein the primary subchannel and each of the secondary subchannels have a bandwidth of 20 MHz.

In Example 9, the subject matter of any one or more of Examples 1-8 optionally include wherein each of the secondary subchannels has a bandwidth of 40 MHz.

In Example 10, the subject matter of any one or more of Examples 1-9 optionally include wherein the subchannel change request message is a medium access control (MAC) frame.

In Example 11, the subject matter of any one or more of Examples 1-10 optionally include wherein the primary subchannel and the plurality of secondary subchannels are orthogonal frequency division multiple access (OFDMA) subchannels.

In Example 12, the subject matter of any one or more of Examples 1-11 optionally include transceiver circuitry coupled to the processing circuitry, and configured to conduct radio communication with the AP on at least the second subchannel specified by the processing circuitry.

Example 13 is an apparatus for a high-efficiency (HE) access point (AP) for operation in a wireless network for which channels are defined to include a primary subchannel and a plurality of secondary subchannels, the apparatus comprising: memory; and processing circuitry, configured to: establish wireless connectivity with a HE client station (STA) on a first subchannel having a subchannel bandwidth that is a fractional portion of a default channel bandwidth defined for the wireless network; determine a set of at least one candidate subchannel to which communications with the STA are to be relocated; encode a subchannel change request message for transmission to the STA, the subchannel change request message indicating the at least one candidate secondary subchannel for the STA to use for communication with the AP; decode a received subchannel change response message sent by the STA, the subchannel response message confirming relocation of the communications to a new secondary subchannel from among the at least one candidate secondary subchannel; and initiate relocation of communication with the STA to the new secondary subchannel.

In Example 14, the subject matter of Example 13 optionally includes wherein the processing circuitry is to further configure the AP to: in response to transmission of the subchannel change request message, wait for a predefined delay duration before conducting further communication with the STA.

In Example 15, the subject matter of any one or more of Examples 13-14 optionally include wherein the subchannel change request message indicates a plurality of available secondary subchannels, and wherein the subchannel change response message indicates selection by the STA of the new secondary subchannel.

In Example 16, the subject matter of any one or more of Examples 13-15 optionally include wherein the processing circuitry is to further configure the AP, in response to the subchannel change request message, to: measure subchannel congestion of a set of secondary subchannels; determine the set of at least one candidate subchannel based on the subchannel congestion measurement wherein one or more secondary subchannels meeting predefined relocation criteria are selected as the at least one candidate subchannel.

In Example 17, the subject matter of any one or more of Examples 13-16 optionally include wherein the first subchannel is the primary subchannel.

In Example 18, the subject matter of any one or more of Examples 13-17 optionally include wherein the subchannel change response message is decoded from reception on the primary subchannel.

In Example 19, the subject matter of any one or more of Examples 13-18 optionally include wherein the subchannel change response message is decoded from reception on the first subchannel.

In Example 20, the subject matter of any one or more of Examples 13-19 optionally include wherein the primary subchannel and each of the secondary subchannels have a bandwidth of 20 MHz.

In Example 21, the subject matter of any one or more of Examples 13-20 optionally include wherein each of the secondary subchannels has a bandwidth of 40 MHz.

In Example 22, the subject matter of any one or more of Examples 13-21 optionally include wherein the subchannel change request message is a medium access control (MAC) frame.

In Example 23, the subject matter of any one or more of Examples 13-22 optionally include wherein the primary subchannel and the plurality of secondary subchannels are orthogonal frequency division multiple access (OFDMA) subchannels.

In Example 24, the subject matter of any one or more of Examples 13-23 optionally include transceiver circuitry coupled to the processing circuitry, and configured to conduct radio communication with the STA on at least the new secondary subchannel specified by the processing circuitry.

Example 25 is an apparatus for a high-efficiency (HE) station (STA) for operation in a wireless network for which channels are defined to include a primary subchannel and a plurality of secondary subchannels, the apparatus comprising: memory; and processing circuitry configured to: initiate wireless connectivity with a HEW access point (AP) on a first subchannel having a subchannel bandwidth that is a fractional portion of a default channel bandwidth defined for the wireless network; determine a set of at least one candidate subchannel to which communications with the STA are to be relocated; encode a subchannel change request message for transmission to the AP, the subchannel change request message indicating the at least one candidate secondary subchannel for the AP to use for communication with the STA; decode a received subchannel change response message sent by the AP, the subchannel response message scheduling relocation of the communications to a new secondary subchannel from among the at least one candidate secondary sub and initiate relocation of communication with the AP to the new secondary subchannel.

In Example 26, the subject matter of Example 25 optionally includes wherein the subchannel change request message indicates a plurality of available secondary subchannels, and wherein the subchannel change response message indicates selection by the AP of the new secondary subchannel.

In Example 27, the subject matter of any one or more of Examples 25-26 optionally include wherein the processing circuitry is to further configure the STA to: measure subchannel congestion of a set of secondary subchannels; determine the set of at least one candidate subchannel based on the subchannel congestion measurement wherein one or more secondary subchannels meeting predefined relocation criteria are selected as the at least one candidate subchannel.

In Example 28, the subject matter of any one or more of Examples 25-27 optionally include wherein the first subchannel is the primary subchannel.

In Example 29, the subject matter of any one or more of Examples 25-28 optionally include wherein the subchannel change response message is decoded from reception on the primary subchannel.

In Example 30, the subject matter of any one or more of Examples 25-29 optionally include wherein the subchannel change response message is decoded from reception on the first subchannel.

In Example 31, the subject matter of any one or more of Examples 25-30 optionally include wherein the primary subchannel and each of the secondary subchannels have a bandwidth of 20 MHz.

In Example 32, the subject matter of any one or more of Examples 25-31 optionally include wherein each of the secondary subchannels has a bandwidth of 40 MHz.

In Example 33, the subject matter of any one or more of Examples 25-32 optionally include wherein the subchannel change request message is a medium access control (MAC) frame.

In Example 34, the subject matter of any one or more of Examples 25-33 optionally include wherein the primary subchannel and the plurality of secondary subchannels are orthogonal frequency division multiple access (OFDMA) subchannels.

In Example 35, the subject matter of any one or more of Examples 25-34 optionally include transceiver circuitry coupled to the processing circuitry, and configured to conduct radio communication with the AP on at least the new secondary subchannel specified by the processing circuitry.

Example 36 is an apparatus for a high-efficiency (HE) access point (AP) for operation in a wireless network for which channels are defined to include a primary subchannel and a plurality of secondary subchannels, the apparatus comprising: memory; and processing circuitry configured to: conduct wireless communication with a client station (STA) on a first subchannel having a subchannel bandwidth that is a fractional portion of a default channel bandwidth defined for the wireless network; decode a received subchannel change request message sent by the STA on the first subchannel, the subchannel change request message indicating a second subchannel for the AP to use for communication with the STA, wherein the second subchannel is a secondary subchannel; in response to the subchannel change request message, encode a subchannel change response message for transmission to the STA; and initiate relocation of communication with the STA to the second subchannel.

In Example 37, the subject matter of Example 36 optionally includes wherein the subchannel change request message indicates a plurality of available secondary subchannels, and wherein the processing circuitry is to further configure the AP to: in response to the subchannel change request message, select the second subchannel from among the plurality of available secondary subchannels as indicated in the subchannel change request message, and indicate the selected second subchannel in the subchannel change response message.

In Example 38, the subject matter of any one or more of Examples 36-37 optionally include wherein the processing circuitry is to further configure the AP, in response to the subchannel change request message, to: measure channel congestion of the second subchannel; compute a relocation determination, based on the channel congestion of the second subchannel, whether relocation to the second subchannel meets predefined relocation criteria; and wherein the subchannel change response message and the relocation to the second are in response to the relocation determination meeting the predefined relocation criteria.

In Example 39, the subject matter of any one or more of Examples 36-38 optionally include wherein the first subchannel is the primary subchannel.

In Example 40, the subject matter of any one or more of Examples 36-39 optionally include wherein the subchannel change response message for transmission to the STA is encoded for transmission on the primary subchannel.

In Example 41, the subject matter of any one or more of Examples 36-40 optionally include wherein the subchannel change response message for transmission to the STA is encoded for transmission on the first subchannel.

In Example 42, the subject matter of any one or more of Examples 36-41 optionally include wherein the primary subchannel and each of the secondary subchannels have a bandwidth of 20 MHz.

In Example 43, the subject matter of any one or more of Examples 36-42 optionally include wherein each of the secondary subchannels has a bandwidth of 40 MHz.

In Example 44, the subject matter of any one or more of Examples 36-43 optionally include wherein the subchannel change request message is a medium access control (MAC) frame.

In Example 45, the subject matter of any one or more of Examples 36-44 optionally include wherein the primary subchannel and the plurality of secondary subchannels are orthogonal frequency division multiple access (OFDMA) subchannels.

In Example 46, the subject matter of any one or more of Examples 36-45 optionally include transceiver circuitry coupled to the processing circuitry, and configured to conduct radio communication with the STA on at least the second subchannel specified by the processing circuitry.

Example 47 is at least one machine-readable medium comprising instructions that, when executed by a high-efficiency (HE) station (STA) device in a wireless network for which channels are defined to include a primary subchannel and a plurality of secondary subchannels, cause the STA to: initiate wireless connectivity with an access point (AP) on a first subchannel having a subchannel bandwidth that is a fractional portion of a default channel bandwidth defined for the wireless network; decode a received subchannel change request message sent by the AP on the first subchannel, the subchannel change request message indicating a second subchannel for the STA to use for communication with the AP, wherein the second subchannel is a secondary subchannel; in response to the subchannel change request message, encode a subchannel change response message for transmission to the AP; and initiate relocation of communication with the AP to the second subchannel.

In Example 48, the subject matter of Example 47 optionally includes wherein the instructions are to further cause the STA to: in response to the subchannel change request message, wait for a predefined delay duration before initiation of relocation of communication to the second subchannel.

In Example 49, the subject matter of any one or more of Examples 47-48 optionally include wherein the subchannel change request message indicates a plurality of available secondary subchannels, and wherein the instructions are to further cause the STA to: in response to the subchannel change request message, select the second subchannel from among the plurality of available secondary subchannels as indicated in the subchannel change request message, and indicate the selected second subchannel in the subchannel change response message.

In Example 50, the subject matter of any one or more of Examples 47-49 optionally include wherein the instructions are to further cause the STA, in response to the subchannel change request message, to: measure channel congestion of the second subchannel; compute a relocation determination, based on the channel congestion of the second subchannel, whether relocation to the second subchannel meets predefined relocation criteria; and wherein the subchannel change response message and the relocation to the second are in response to the relocation determination meeting the predefined relocation criteria.

In Example 51, the subject matter of any one or more of Examples 47-50 optionally include wherein the first subchannel is the primary subchannel.

In Example 52, the subject matter of any one or more of Examples 47-51 optionally include wherein the subchannel change response message for transmission to the AP is encoded for transmission on the primary subchannel.

In Example 53, the subject matter of any one or more of Examples 47-52 optionally include wherein the subchannel change response message for transmission to the AP is encoded for transmission on the first subchannel.

In Example 54, the subject matter of any one or more of Examples 47-53 optionally include wherein the primary subchannel and each of the secondary subchannels have a bandwidth of 20 MHz.

In Example 55, the subject matter of any one or more of Examples 47-54 optionally include wherein each of the secondary subchannels has a bandwidth of 40 MHz.

In Example 56, the subject matter of any one or more of Examples 47-55 optionally include wherein the subchannel change request message is a medium access control (MAC) frame.

In Example 57, the subject matter of any one or more of Examples 47-56 optionally include wherein the primary subchannel and the plurality of secondary subchannels are orthogonal frequency division multiple access (OFDMA) subchannels.

Example 58 is at least one machine-readable medium comprising instructions that, when executed by a high-efficiency (HE) access point (AP) for operation in a wireless network for which channels are defined to include a primary subchannel and a plurality of secondary subchannels, cause the AP to: establish wireless connectivity with a HE client station (STA) on a first subchannel having a subchannel bandwidth that is a fractional portion of a default channel bandwidth defined for the wireless network; determine a set of at least one candidate subchannel to which communications with the STA are to be relocated; encode a subchannel change request message for transmission to the STA, the subchannel change request message indicating the at least one candidate secondary subchannel for the STA to use for communication with the AP; decode a received subchannel change response message sent by the STA, the subchannel response message confirming relocation of the communications to a new secondary subchannel from among the at least one candidate secondary subchannel; and initiate relocation of communication with the STA to the new secondary subchannel.

In Example 59, the subject matter of Example 58 optionally includes wherein the instructions are to further cause the AP to: in response to transmission of the subchannel change request message, wait for a predefined delay duration before conducting further communication with the STA.

In Example 60, the subject matter of any one or more of Examples 58-59 optionally include wherein the subchannel change request message indicates a plurality of available secondary subchannels, and wherein the subchannel change response message indicates selection by the STA of the new secondary subchannel.

In Example 61, the subject matter of any one or more of Examples 58-60 optionally include wherein the instructions are to further cause the AP, in response to the subchannel change request message, to: measure subchannel congestion of a set of secondary subchannels; determine the set of at least one candidate subchannel based on the subchannel congestion measurement wherein one or more secondary subchannels meeting predefined relocation criteria are selected as the at least one candidate subchannel.

In Example 62, the subject matter of any one or more of Examples 58-61 optionally include wherein the first subchannel is the primary subchannel.

In Example 63, the subject matter of any one or more of Examples 58-62 optionally include wherein the subchannel change response message is decoded from reception on the primary subchannel.

In Example 64, the subject matter of any one or more of Examples 58-63 optionally include wherein the subchannel change response message is decoded from reception on the first subchannel.

In Example 65, the subject matter of any one or more of Examples 58-64 optionally include wherein the primary subchannel and each of the secondary subchannels have a bandwidth of 20 MHz.

In Example 66, the subject matter of any one or more of Examples 58-65 optionally include wherein each of the secondary subchannels has a bandwidth of 40 MHz.

In Example 67, the subject matter of any one or more of Examples 58-66 optionally include wherein the subchannel change request message is a medium access control (MAC) frame.

In Example 68, the subject matter of any one or more of Examples 58-67 optionally include wherein the primary subchannel and the plurality of secondary subchannels are orthogonal frequency division multiple access (OFDMA) subchannels.

Example 69 is at least one machine-readable medium comprising instructions that, when executed by a high-efficiency (HE) station (STA) for operation in a wireless network for which channels are defined to include a primary subchannel and a plurality of secondary subchannels, cause the STA to: initiate wireless connectivity with a HEW access point (AP) on a first subchannel having a subchannel bandwidth that is a fractional portion of a default channel bandwidth defined for the wireless network; determine a set of at least one candidate subchannel to which communications with the STA are to be relocated; encode a subchannel change request message for transmission to the AP, the subchannel change request message indicating the at least one candidate secondary subchannel for the AP to use for communication with the STA; decode a received subchannel change response message sent by the AP, the subchannel response message scheduling relocation of the communications to a new secondary subchannel from among the at least one candidate secondary subchannel; and initiate relocation of communication with the AP to the new secondary subchannel.

In Example 70, the subject matter of Example 69 optionally includes wherein the subchannel change request message indicates a plurality of available secondary subchannels, and wherein the subchannel change response message indicates selection by the AP of the new secondary subchannel.

In Example 71, the subject matter of any one or more of Examples 69-70 optionally include wherein the instructions are to further cause the STA to: measure subchannel congestion of a set of secondary subchannels; determine the set of at least one candidate subchannel based on the subchannel congestion measurement wherein one or more secondary subchannels meeting predefined relocation criteria are selected as the at least one candidate subchannel.

In Example 72, the subject matter of any one or more of Examples 69-71 optionally include wherein the first subchannel is the primary subchannel.

In Example 73, the subject matter of any one or more of Examples 69-72 optionally include wherein the subchannel change response message is decoded from reception on the primary subchannel.

In Example 74, the subject matter of any one or more of Examples 69-73 optionally include wherein the subchannel change response message is decoded from reception on the first subchannel.

In Example 75, the subject matter of any one or more of Examples 69-74 optionally include wherein the primary subchannel and each of the secondary subchannels have a bandwidth of 20 MHz.

In Example 76, the subject matter of any one or more of Examples 69-75 optionally include wherein each of the secondary subchannels has a bandwidth of 40 MHz.

In Example 77, the subject matter of any one or more of Examples 69-76 optionally include wherein the subchannel change request message is a medium access control (MAC) frame.

In Example 78, the subject matter of any one or more of Examples 69-77 optionally include wherein the primary subchannel and the plurality of secondary subchannels are orthogonal frequency division multiple access (OFDMA) subchannels.

Example 79 is at least one machine-readable medium comprising instructions that, when executed by a high-efficiency (HE) access point (AP) for operation in a wireless network for which channels are defined to include a primary subchannel and a plurality of secondary subchannels, cause the AP to: conduct wireless communication with a client station (STA) on a first subchannel having a subchannel bandwidth that is a fractional portion of a default channel bandwidth defined for the wireless network; decode a received subchannel change request message sent by the STA on the first subchannel, the subchannel change request message indicating a second subchannel for the AP to use for communication with the STA, wherein the second subchannel is a secondary subchannel; in response to the subchannel change request message, encode a subchannel change response message for transmission to the STA; and initiate relocation of communication with the STA to the second subchannel.

In Example 80, the subject matter of Example 79 optionally includes wherein the subchannel change request message indicates a plurality of available secondary subchannels, and wherein the instructions are to further cause the AP to: in response to the subchannel change request message, select the second subchannel from among the plurality of available secondary subchannels as indicated in the subchannel change request message, and indicate the selected second subchannel in the subchannel change response message.

In Example 81, the subject matter of any one or more of Examples 79-80 optionally include wherein the instructions are to further cause the AP, in response to the subchannel change request message, to: measure channel congestion of the second subchannel; compute a relocation determination, based on the channel congestion of the second subchannel, whether relocation to the second subchannel meets predefined relocation criteria; and wherein the subchannel change response message and the relocation to the second are in response to the relocation determination meeting the predefined relocation criteria.

In Example 82, the subject matter of any one or more of Examples 79-81 optionally include wherein the first subchannel is the primary subchannel.

In Example 83, the subject matter of any one or more of Examples 79-82 optionally include wherein the subchannel change response message for transmission to the STA is encoded for transmission on the primary subchannel.

In Example 84, the subject matter of any one or more of Examples 79-83 optionally include wherein the subchannel change response message for transmission to the STA is encoded for transmission on the first subchannel.

In Example 85, the subject matter of any one or more of Examples 79-84 optionally include wherein the primary subchannel and each of the secondary subchannels have a bandwidth of 20 MHz.

In Example 86, the subject matter of any one or more of Examples 79-85 optionally include wherein each of the secondary subchannels has a bandwidth of 40 MHz.

In Example 87, the subject matter of any one or more of Examples 79-86 optionally include wherein the subchannel change request message is a medium access control (MAC) frame.

In Example 88, the subject matter of any one or more of Examples 79-87 optionally include wherein the primary subchannel and the plurality of secondary subchannels are orthogonal frequency division multiple access (OFDMA) subchannels.

Example 89 is a system for use with a high-efficiency (HE) station (STA) for operation in a wireless network for which channels are defined to include a primary subchannel and a plurality of secondary subchannels, the system comprising: means for initiating wireless connectivity with an access point (AP) on a first subchannel having a subchannel bandwidth that is a fractional portion of a default channel bandwidth defined for the wireless network; means for decoding a received subchannel change request message sent by the AP on the first subchannel, the subchannel change request message indicating a second subchannel for the STA to use for communication with the AP, wherein the second subchannel is a secondary subchannel; means for encoding, in response to the subchannel change request message, a subchannel change response message for transmission to the AP; and means for initiating relocation of communication with the AP to the second subchannel.

In Example 90, the subject matter of Example 89 optionally includes means for further configuring the STA to: in response to the subchannel change request message, wait for a predefined delay duration before initiation of relocation of communication to the second subchannel.

In Example 91, the subject matter of any one or more of Examples 89-90 optionally include wherein the subchannel change request message indicates a plurality of available secondary subchannels, and wherein the system further comprises: means for selecting the second subchannel from among the plurality of available secondary subchannels as indicated in the subchannel change request message, and for indicating the selected second subchannel in the subchannel change response message, in response to the subchannel change request message.

In Example 92, the subject matter of any one or more of Examples 89-91 optionally include wherein the system is to further configure the STA, in response to the subchannel change request message, to: measure channel congestion of the second subchannel; compute a relocation determination, based on the channel congestion of the second subchannel, whether relocation to the second subchannel meets predefined relocation criteria; and wherein the subchannel change response message and the relocation to the second are in response to the relocation determination meeting the predefined relocation criteria.

In Example 93, the subject matter of any one or more of Examples 89-92 optionally include wherein the first subchannel is the primary subchannel.

In Example 94, the subject matter of any one or more of Examples 89-93 optionally include wherein the subchannel change response message for transmission to the AP is encoded for transmission on the primary subchannel.

In Example 95, the subject matter of any one or more of Examples 89-94 optionally include wherein the subchannel change response message for transmission to the AP is encoded for transmission on the first subchannel.

In Example 96, the subject matter of any one or more of Examples 89-95 optionally include wherein the primary subchannel and each of the secondary subchannels have a bandwidth of 20 MHz.

In Example 97, the subject matter of any one or more of Examples 89-96 optionally include wherein each of the secondary subchannels has a bandwidth of 40 MHz.

In Example 98, the subject matter of any one or more of Examples 89-97 optionally include wherein the subchannel change request message is a medium access control (MAC) frame.

In Example 99, the subject matter of any one or more of Examples 89-98 optionally include wherein the primary subchannel and the plurality of secondary subchannels are orthogonal frequency division multiple access (OFDMA) subchannels.

In Example 100, the subject matter of any one or more of Examples 89-99 optionally include transceiver means for conducting radio communication with the AP on at least the second subchannel specified by the system.

Example 101 is a system of a high-efficiency (HE) access point (AP) for operation in a wireless network for which channels are defined to include a primary subchannel and a plurality of secondary subchannels, the system comprising: means for establishing wireless connectivity with a HE client station (STA) on a first subchannel having a subchannel bandwidth that is a fractional portion of a default channel bandwidth defined for the wireless network; means for determining a set of at least one candidate subchannel to which communications with the STA are to be relocated; means for encoding a subchannel change request message for transmission to the STA, the subchannel change request message indicating the at least one candidate secondary subchannel for the STA to use for communication with the AP; means for decoding a received subchannel change response message sent by the STA, the subchannel response message confirming relocation of the communications to a new secondary subchannel from among the at least one candidate secondary subchannel; and means for initiating relocation of communication with the STA to the new secondary subchannel.

In Example 102, the subject matter of Example 101 optionally includes wherein the system is to further configure the AP to: in response to transmission of the subchannel change request message, wait for a predefined delay duration before conducting further communication with the STA.

In Example 103, the subject matter of any one or more of Examples 101-102 optionally include wherein the subchannel change request message indicates a plurality of available secondary subchannels, and wherein the subchannel change response message indicates selection by the STA of the new secondary subchannel.

In Example 104, the subject flatter of any one or more of Examples 101-103 optionally include wherein the system is to further configure the AP, in response to the subchannel change request message, to: measure subchannel congestion of a set of secondary subchannels; determine the set of at least one candidate subchannel based on the subchannel congestion measurement wherein one or more secondary subchannels meeting predefined relocation criteria are selected as the at least one candidate subchannel.

In Example 105, the subject matter of any one or more of Examples 101-104 optionally include wherein the first subchannel is the primary subchannel.

In Example 106, the subject matter of any one or more of Examples 101-105 optionally include wherein the subchannel change response message is decoded from reception on the primary subchannel.

In Example 107, the subject matter of any one or more of Examples 101-106 optionally include wherein the subchannel change response message is decoded from reception on the first subchannel.

In Example 108, the subject flatter of any one or more of Examples 101-107 optionally include wherein the primary subchannel and each of the secondary subchannels have a bandwidth of 20 MHz.

In Example 109, the subject matter of any one or more of Examples 101-108 optionally include wherein each of the secondary subchannels has a bandwidth of 40 MHz.

In Example 110, the subject matter of any one or more of Examples 101-109 optionally include wherein the subchannel change request message is a medium access control (MAC) frame.

In Example 111, the subject matter of any one or more of Examples 101-110 optionally include wherein the primary subchannel and the plurality of secondary subchannels are orthogonal frequency division multiple access (OFDMA) subchannels.

In Example 112, the subject matter of any one or more of Examples 101-111 optionally include transceiver means for conducting radio communication with the STA on at least the new secondary subchannel specified by the system.

Example 113 is a system of a high-efficiency (HE) station (STA) for operation in a wireless network for which channels are defined to include a primary subchannel and a plurality of secondary subchannels, the system comprising: means for initiating wireless connectivity with a HEW access point (AP) on a first subchannel having a subchannel bandwidth that is a fractional portion of a default channel bandwidth defined for the wireless network; means for determining a set of at least one candidate subchannel to which communications with the STA are to be relocated; means for encoding a subchannel change request message for transmission to the AP, the subchannel change request message indicating the at least one candidate secondary subchannel for the AP to use for communication with the STA; means for decoding a received subchannel change response message sent by the AP, the subchannel response message scheduling relocation of the communications to a new secondary subchannel from among the at least one candidate secondary subchannel; and means for initiating relocation of communication with the AP to the new secondary subchannel.

In Example 114, the subject matter of Example 113 optionally includes wherein the subchannel change request message indicates a plurality of available secondary subchannels, and wherein the subchannel change response message indicates selection by the AP of the new secondary subchannel.

In Example 115, the subject matter of any one or more of Examples 113-114 optionally include wherein the system is to further configure the STA to: measure subchannel congestion of a set of secondary subchannels; determine the set of at least one candidate subchannel based on the subchannel congestion measurement wherein one or more secondary subchannels meeting predefined relocation criteria are selected as the at least one candidate subchannel.

In Example 116, the subject matter of any one or more of Examples 113-115 optionally include wherein the first subchannel is the primary subchannel.

In Example 117, the subject matter of any one or more of Examples 113-116 optionally include wherein the subchannel change response message is decoded from reception on the primary subchannel.

In Example 118, the subject matter of any one or more of Examples 113-117 optionally include wherein the subchannel change response message is decoded from reception on the first subchannel.

In Example 119, the subject matter of any one or more of Examples 113-118 optionally include wherein the primary subchannel and each of the secondary subchannels have a bandwidth of 20 MHz.

In Example 120, the subject flatter of any one or more of Examples 113-119 optionally include wherein each of the secondary subchannels has a bandwidth of 40 MHz.

In Example 121, the subject matter of any one or more of Examples 113-120 optionally include wherein the subchannel change request message is a medium access control (MAC) frame.

In Example 122, the subject matter of any one or more of Examples 113-121 optionally include wherein the primary subchannel and the plurality of secondary subchannels are orthogonal frequency division multiple access (OFDMA) subchannels.

In Example 123, the subject matter of any one or more of Examples 113-122 optionally include transceiver means for conducting radio communication with the AP on at least the new secondary subchannel specified by the system.

Example 124 is a system of a high-efficiency (HE) access point (AP) for operation in a wireless network for which channels ate defined to include a primary subchannel and a plurality of secondary subchannels, the system comprising: means for conducting wireless communication with a client station (STA) on a first subchannel having a subchannel bandwidth that is a fractional portion of a default channel bandwidth defined for the wireless network; means for decoding a received subchannel change request message sent by the STA on the first subchannel, the subchannel change request message indicating a second subchannel for the AP to use for communication with the STA, wherein the second subchannel is a secondary subchannel; means for encoding, in response to the subchannel change request message, a subchannel change response message for transmission to the STA; and means for initiating relocation of communication with the STA to the second subchannel.

In Example 125, the subject matter of Example 124 optionally includes wherein the subchannel change request message indicates a plurality of available secondary subchannels, and wherein the system is to further configure the AP to: in response to the subchannel change request message, select the second subchannel from among the plurality of available secondary subchannels as indicated in the subchannel change request message, and indicate the selected second subchannel in the subchannel change response message.

In Example 126, the subject flatter of any one or more of Examples 124-125 optionally include wherein the system is to further configure the AP, in response to the subchannel change request message, to: measure channel congestion of the second subchannel; compute a relocation determination, based on the channel congestion of the second subchannel, whether relocation to the second subchannel meets predefined relocation criteria; and wherein the subchannel change response message and the relocation to the second are in response to the relocation determination meeting the predefined relocation criteria.

In Example 127, the subject matter of any one or more of Examples 124-126 optionally include wherein the first subchannel is the primary subchannel.

In Example 128, the subject matter of any one or more of Examples 124-127 optionally include wherein the subchannel change response message for transmission to the STA is encoded for transmission on the primary subchannel.

In Example 129, the subject matter of any one or more of Examples 124-128 optionally include wherein the subchannel change response message for transmission to the STA is encoded for transmission on the first subchannel.

In Example 130, the subject matter of any one or more of Examples 124-129 optionally include wherein the primary subchannel and each of the secondary subchannels have a bandwidth of 20 MHz.

In Example 131, the subject matter of any one or more of Examples 124-130 optionally include wherein each of the secondary subchannels has a bandwidth of 40 MHz.

In Example 132, the subject matter of any one or more of Examples 124-131 optionally include wherein the subchannel change request message is a medium access control (MAC) frame.

In Example 133, the subject matter of any one or more of Examples 124-132 optionally include wherein the primary subchannel and the plurality of secondary subchannels are orthogonal frequency division multiple access (OFDMA) subchannels.

In Example 134, the subject matter of any one or more of Examples 124-133 optionally include transceiver means for conducting radio communication with the STA on at least the second subchannel specified by the system.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An apparatus for a high-efficiency (HE) station (STA) for operation in a wireless network for which channels are defined to include a primary subchannel and a plurality of secondary subchannels, the apparatus comprising: memory; and processing circuitry configured to:
initiate wireless connectivity with an access point (AP) on a first subchannel having a subchannel bandwidth that is a fractional portion of a default channel bandwidth defined for the wireless network;
decode a received subchannel change request message sent by the AP on the first subchannel, the subchannel change request message indicating a second subchannel for the STA to use for communication with the AP, wherein the second subchannel is a secondary subchannel;
in response to the subchannel change request message, encode a subchannel change response message for transmission to the AP; and
initiate relocation of communication with the AP to the second subchannel.

2. The apparatus of claim 1, wherein the processing circuitry is to further configure the STA to:
in response to the subchannel change request message, wait for a predefined delay duration before initiation of relocation of communication to the second subchannel.

3. The apparatus of claim 1, wherein the subchannel change request message indicates a plurality of available secondary subchannels, and wherein the processing circuitry is to further configure the STA to:
in response to the subchannel change request message, select the second subchannel from among the plurality of available secondary subchannels as indicated in the subchannel change request message, and indicate the selected second subchannel in the subchannel change response message.

4. The apparatus of claim 1, wherein the processing circuitry is to further configure the STA, in response to the subchannel change request message, to:
measure channel congestion of the second subchannel;
compute a relocation determination, based on the channel congestion of the second subchannel, whether relocation to the second subchannel meets predefined relocation criteria; and
wherein the subchannel change response message and the relocation to the second are in response to the relocation determination meeting the predefined relocation criteria.

5. The apparatus of claim 1, wherein the first subchannel is the primary subchannel.

6. The apparatus of claim 1, wherein the subchannel change request message is a medium access control (MAC) frame.

7. The apparatus of claim 1, further comprising:
transceiver circuitry coupled to the processing circuitry, and configured to conduct radio communication with the AP on at least the second subchannel specified by the processing circuitry.

8. An apparatus for a high-efficiency (HE) access point (AP) for operation in a wireless network for which channels are defined to include a primary subchannel and a plurality of secondary subchannels, the apparatus comprising: memory; and processing circuitry configured to:
conduct wireless communication with a client station (STA) on a first subchannel having a subchannel bandwidth that is a fractional portion of a default channel bandwidth defined for the wireless network;
decode a received subchannel change request message sent by the STA on the first subchannel, the subchannel change request message indicating a second subchannel for the AP to use for communication with the STA, wherein the second subchannel is a secondary subchannel;
in response to the subchannel change request message, encode a subchannel change response message for transmission to the STA; and
initiate relocation of communication with the STA to the second subchannel.

9. The apparatus of claim 8, wherein the subchannel change request message indicates a plurality of available secondary subchannels, and wherein the processing circuitry is to further configure the AP to:
in response to the subchannel change request message, select the second subchannel from among the plurality of available secondary subchannels as indicated in the subchannel change request message, and indicate the selected second subchannel in the subchannel change response message.

10. The apparatus of claim 8, wherein the processing circuitry is to further configure the AP, in response to the subchannel change request message, to:
measure channel congestion of the second subchannel;
compute a relocation determination, based on the channel congestion of the second subchannel, whether relocation to the second subchannel meets predefined relocation criteria; and
wherein the subchannel change response message and the relocation to the second are in response to the relocation determination meeting the predefined relocation criteria.

11. The apparatus of claim 8, wherein the first subchannel is the primary subchannel.

12. The apparatus of claim 8, wherein the subchannel change response message for transmission to the STA is encoded for transmission on the primary subchannel.

13. The apparatus of claim 8, wherein the subchannel change response message for transmission to the STA is encoded for transmission on the first subchannel.

14. At least one machine-readable medium comprising instructions that, when executed by a high-efficiency (HE) access point (AP) for operation in a wireless network for which channels are defined to include a primary subchannel and a plurality of secondary subchannels, cause the AP to:
establish wireless connectivity with a HE client station (STA) on a first subchannel having a subchannel bandwidth that is a fractional portion of a default channel bandwidth defined for the wireless network;
determine a set of at least one candidate subchannel to which communications with the STA are to be relocated;
encode a subchannel change request message for transmission to the STA, the subchannel change request message indicating the at least one candidate secondary subchannel for the STA to use for communication with the AP;
decode a received subchannel change response message sent by the STA, the subchannel response message confirming relocation of the communications to a new secondary subchannel from among the at least one candidate secondary subchannel; and
initiate relocation of communication with the STA to the new secondary subchannel.

15. The at least one machine-readable medium of claim 14, wherein the instructions are to further cause the AP to:
in response to transmission of the subchannel change request message, wait for a predefined delay duration before conducting further communication with the STA.

16. The at least one machine-readable medium of claim 14, wherein the subchannel change request message indicates a plurality of available secondary subchannels, and wherein the subchannel change response message indicates selection by the STA of the new secondary subchannel.

17. The at least one machine-readable medium of claim 14, wherein the instructions are to further cause the AP, in response to the subchannel change request message, to:
measure subchannel congestion of a set of secondary subchannels;
determine the set of at least one candidate subchannel based on the subchannel congestion measurement wherein one or more secondary subchannels meeting predefined relocation criteria are selected as the at least one candidate subchannel.

18. The at least one machine-readable medium of claim 14, wherein the first subchannel is the primary subchannel.

19. The at least one machine-readable medium of claim 14, wherein the subchannel change request message is a medium access control (MAC) frame.

20. The at least one machine-readable medium of claim 14, wherein the primary subchannel and the plurality of secondary subchannels are orthogonal frequency division multiple access (OFDMA) subchannels.

21. At least one machine-readable medium comprising instructions that, when executed by a high-efficiency (HE) station (STA) for operation in a wireless network for which channels are defined to include a primary subchannel and a plurality of secondary subchannels, cause the STA to:
initiate wireless connectivity with a HEW access point (AP) on a first subchannel having a subchannel bandwidth that is a fractional portion of a default channel bandwidth defined for the wireless network;
determine a set of at least one candidate subchannel to which communications with the STA are to be relocated;
encode a subchannel change request message for transmission to the AP, the subchannel change request message indicating the at least one candidate secondary subchannel for the AP to use for communication with the STA;
decode a received subchannel change response message sent by the AP, the subchannel response message scheduling relocation of the communications to a new secondary subchannel from among the at least one candidate secondary subchannel; and
initiate relocation of communication with the AP to the new secondary subchannel.

22. The at least one machine-readable medium of claim 21, wherein the subchannel change request message indicates a plurality of available secondary subchannels, and wherein the subchannel change response message indicates selection by the AP of the new secondary subchannel.

23. The at least one machine-readable medium of claim 21, wherein the instructions are to further cause the STA to:
measure subchannel congestion of a set of secondary subchannels;
determine the set of at least one candidate subchannel based on the subchannel congestion measurement wherein one or more secondary subchannels meeting predefined relocation criteria are selected as the at least one candidate subchannel.

24. The at least one machine-readable medium of claim 21, wherein the first subchannel is the primary subchannel.

25. The at least one machine-readable medium of claim 21, wherein the subchannel change response message is decoded from reception on the primary subchannel.

26. The at least one machine-readable medium of claim 21, wherein the subchannel change response message is decoded from reception on the first subchannel.

27. The at least one machine-readable medium of claim 21, wherein the primary subchannel and each of the secondary subchannels have a bandwidth of 20 MHz.
